(19) United States
(12) Patent Application Publication
(10) Pub. No.: US 2011/0209972 A1
(43) Pub. Date: Sep. 1, 2011

(54) INSTALLATION SWITCHING DEVICE HAVING A SCREWLESS CLAMP TERMINAL

(75) Inventors: Klaus-Peter EPPE, Waldbrunn (DE); Albert Stieger, Plankstadt (DE); Carola Thielen, Birkenau-Lohrbach (DE); Erwin Muders, Heidelberg (DE)

(73) Assignee: ABB AG, Mannheim (DE)

(21) Appl. No.: 13/074,570

(22) Filed: Mar. 29, 2011

Related U.S. Application Data
(63) Continuation of application No. PCT/EP2009/006726, filed on Sep. 17, 2009.

(30) Foreign Application Priority Data
Sep. 29, 2008 (DE) 10 2008 049 326.0

(51) Int. Cl. H01H 9/02

(52) U.S. Cl. 200/293

(57) ABSTRACT

Exemplary embodiments are directed to an installation switching device, having a housing with a front side, a fastening side, narrow sides, and wide sides. The device also includes a screwless clamp terminal with a clamping spring for connecting conductors. The clamping spring is fixed in position in a clamp terminal chamber of the housing. The opening of the clamp terminal chamber can be partially covered by a clamp covering part which is pivotably connected to the housing. The clamp covering part includes a number of connection openings in a connection area, the number corresponding to the number of connecting conductors to be connected. The clamp covering part can act against the clamping spring in an opening manner in pivoting in the direction of the housing interior.

### RELATED APPLICATIONS

This application claims priority as a continuation application under 35 U.S.C. §120 to PCT/EP2009/006726, which was filed as an International Application on Sep. 17, 2009 designating the U.S., and which claims priority to German Application 10 2008 049 326.0 filed in Germany on Sep. 29, 2008. The entire contents of these applications are hereby incorporated by reference in their entireties.

### FIELD

The disclosure relates to a switching device, such as, an installation switching device having a screwless clamp terminal, in particular a line circuit breaker, a residual current circuit breaker, a motor circuit breaker or the like, with a housing, which comprises a front-panel side, a fastening side, and narrow and broad sides. The screwless terminal connection has a clamping spring for the connection of connecting conductors, which clamping spring is fixed in position in a terminal connection area of the housing, wherein the opening of the terminal connection area can be covered partially by a terminal cover part, which is connected pivotably to the housing, has a number of connecting openings in a connecting surface which corresponds to the number of connecting conductors to be connected and can act upon the clamping spring so as to open it when pivoted in the direction towards the housing interior.

### BACKGROUND INFORMATION

A conventional generic installation switching device is disclosed, for example, in DE 10 2006 047 254 A1, DE 10 2007 043 801 A1 and DE 10 2007 044 069 A1, the content of each document being incorporated in its entirety into the present disclosure by reference. The installation switching device can be, for example, a line circuit breaker, a residual current circuit breaker, a motor circuit breaker or the like. Within its housing the installation switching device can include at least one contact point with at least a fixed and a movable contact piece, via which a current path leading from an input terminal to an output terminal can be opened and closed. In general, the contact point can be actuated by a switching mechanism with a latching point. An installation switching device of the generic type can furthermore include tripping devices, for example a thermal release or a quick-response magnetic release, which, in the event of the occurrence of a short-circuit current or residual current in the current path, act on the contact point or the switching mechanism such that the contact point can then be opened.

In the conventional installation switching device, the terminal connection can be configured in a simple and inexpensive manner in such a way that it is possible for connecting lines to be inserted and withdrawn without the use of a tool. The connecting openings in this case can be dimensioned to be large enough to enable simple and problem-free insertion and withdrawal of the connecting conductor without said connecting conductor becoming jammed. The connecting opening provided should be larger than the outer cross section of the connecting conductor. As a result, however, contact-making problems can arise if the connecting conductor is not guided and supported sufficiently closely in the connecting openings.

### SUMMARY

An exemplary embodiment is directed to an installation switching device, having a housing with a front side, a fastening side, narrow sides, and wide sides. The device also includes a screwless clamp terminal with a clamping spring for connecting conductors. The clamping spring is fixed in position in a clamp terminal chamber of the housing. The opening of the clamp terminal chamber can be partially covered by a clamp covering part which is pivotably connected to the housing. The clamp covering part includes a number of connection openings in a connection area, said number corresponding to the number of connecting conductors to be connected. The clamp covering part can act against the clamping spring in an opening manner in pivoting in the direction of the housing interior. The opening of the clamp terminal chamber can be partially covered also by a guide part rigidly coupled with the housing and overlapping with the clamp covering part in areas, said guide part comprising guide channels for narrowly guiding the connecting conductors.

### BRIEF DESCRIPTION OF THE DRAWINGS

The disclosure and further advantageous configurations and improvements of the disclosure will be explained and described in more detail with reference to the drawings, which illustrate two exemplary embodiments of the disclosure and in which:

FIG. 1 illustrates an exploded view of a terminal accommodating area of an installation switching device in accordance with a first exemplary embodiment;

FIG. 2 illustrates a terminal accommodating area with a terminal cover part and guide part inserted in accordance with a first exemplary embodiment;

FIG. 3 illustrates a three-dimensional view of a terminal accommodating area in accordance with a first exemplary embodiment;

FIG. 4 illustrates an installation switching device with a connecting conductor inserted, in accordance with a first exemplary embodiment;

FIG. 5 illustrates an exploded view of a terminal accommodating area of an installation switching device, in accordance with a second exemplary embodiment;

FIG. 6 illustrates a terminal accommodating area with a terminal cover part and guide part inserted, in accordance with a second exemplary embodiment;

FIG. 7 illustrates a three-dimensional view of a terminal accommodating area in accordance with a second exemplary embodiment; and

FIG. 8 illustrates an installation switching device having a connecting conductor inserted in accordance with a second exemplary embodiment.

Identical or functionally identical component parts or elements have been provided with the same reference symbols.

### DETAILED DESCRIPTION

It is therefore an object of the present disclosure to develop a generic installation switching device having a screwless connection terminal for ensuring close guidance and support of the connecting conductor and easy movability of the conductor.

According to the present disclosure, therefore, the opening in the terminal connection area can be partially covered by a guide part, which is fixedly coupled to the housing, overlaps a region of the terminal cover part, and has guide channels for narrowly guiding the connecting conductors. The advantageous effect achieved thereby in accordance with the present disclosure is based on the fact that the two partially contradictory requirements as regards close guidance and at the same time good movability are assigned to two separate component parts. The guide part, which is coupled fixedly to the housing, serves the purpose of closely guiding the connecting conductors in the guide channels. The terminal cover part transmits the actuation forces onto the clamping spring, which initially, when the connecting conductors are removed, results in the connecting conductors being released by the clamping spring, but with the connecting conductors still being guided and held in the guide channels.

In accordance with an exemplary embodiment of the present disclosure, the guide part and the terminal cover part overlap one another in the region of the guide channels and the connecting openings.

Another exemplary embodiment of the present disclosure includes the guide part forming a stop edge for an inserted connecting conductor. Thus, undesired actuation of the clamping spring by the connecting conductor can be prevented.

In an exemplary embodiment of the present disclosure, the guide channels can have a closed cross-sectional contour. For example, the guide channels can have a circular cross section.

In another exemplary embodiment of the present disclosure, the guide channels can have a partially open cross-sectional contour. For example, the guide channels can have a segment-like opening of the cross-sectional contour with an opening angle of less than 180°. Stated differently, the cross-sectional contour in this embodiment is not open in the form of a “U,” but has an approximately Ω-shaped cross-sectional contour. The opening in the cross-sectional contour of the guide channels points in the direction towards the clamping spring. However, in this embodiment, the connecting conductor cannot slide laterally out of the guide channel, but is still held in the channel interior owing to the Ω-shaped cross section.

In a further exemplary embodiment of the present disclosure, the terminal cover part can be in the form of an “L,” wherein the pivot axis is located at the free end of the long L limb, and the short limb serves to cover the terminal connection area in the direction of the rear front-panel side. The terminal cover part can have a pressure surface, which is accessible from the outside and can be actuated manually, at the transition between the long limb and the short limb.

In another exemplary embodiment of the present disclosure, the guide part can be in the form of a box which is open on one side and has side faces which can be latched with the broad sides of the housing.

In this embodiment, a front side of the guide part can be extended in the direction towards the pivot axis, with the result that it forms part of the rear narrow side of the housing.

In a further exemplary embodiment of the present disclosure, the guide part can be in the form of an “L,” wherein a first limb bears the guide channels and overlaps with the connecting surface of the terminal cover part. In this case, the first limb can be coupled fixedly to the housing and, in the installed position, can point into the housing interior from the narrow side.

In addition, a second limb can be integrally formed on a free end of the first limb which is located in the housing interior. The second limb extending in a direction towards the front-panel side of the housing and forming part of the narrow side cover on the front-panel side.

In another exemplary embodiment of the present disclosure, a sliding surface can be integrally formed on the guide part, which sliding surface points into the interior of the housing and serves to guide the terminal cover part during its pivoting movement. In the L-shaped variant of the guide part, the guide surface can be integrally formed on a free end of the second limb. In the box-shaped variant of the guide part, the guide surface can be integrally formed on a narrow side of the box.

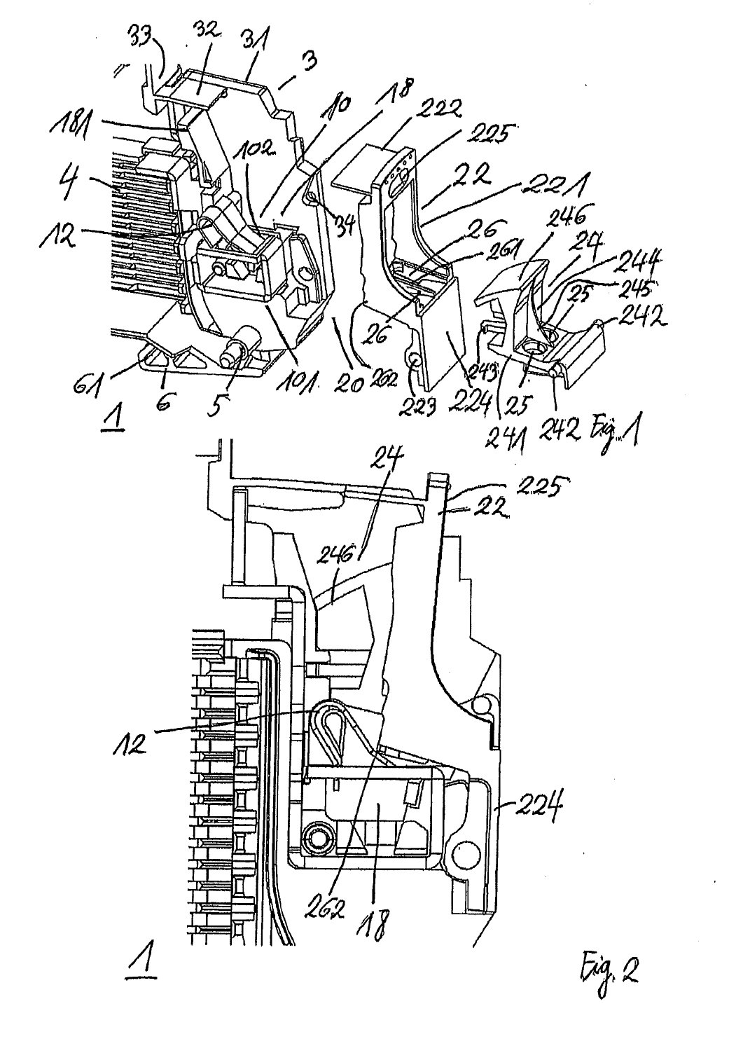

Consideration will first be given to FIGS. 1 to 4, which show a first exemplary embodiment of the present disclosure. FIG. 1 illustrates an exploded view into a first terminal accommodating area of an installation switching device 1 according to a first exemplary embodiment. The view includes a terminal cover part 22, and a guide part 24, which are fitted to the housing of the installation switching device to close off the housing towards its narrow side. The installation switching device can be a line circuit breaker, a residual current circuit breaker, a motor circuit breaker or any other suitable circuit breaker as desired. The housing 3 of the installation switching device, includes part of the broad side 31, part of the rear front-panel side 32, part of the front narrow side 33, and part of the fastening side 6. A fixed tab 61, with which the housing 3 can be held on a limb of a top-hat rail, is located on the fastening side 6.

FIG. 1 also shows, partially, an arc splitter stack 4, which is part of an arc crunching device assigned to the contact point (not illustrated) of the installation switching device 1. Other parts and components of a generic installation switching device, such as the contact point with a fixed and a movable contact piece on a movable contact lever, a switching mechanism and a thermal and/or electro-magnetic release assembly, as well as arc splitter plates and electrical conductors, are not illustrated in FIG. 1 since they are known from the prior art. As shown in FIG. 1, the housing of the installation switching device is configured with a so-called shell-like design, i.e. it includes two housing half-shells along a circumferential abutment edge. The two housing half-shells are held together by fastening means, usually riveting elements, screws or snap-action hooks. Only one half-shell is shown in the illustration shown in FIG. 1 and the mating piece which would complete the housing is not illustrated.

The area between the rear front-panel side 32, the fastening side 6, and the broad side 31 is referred to as the terminal connection area 18. As shown on the left in FIG. 1, the terminal connection housing is open towards the narrow side of the housing 3 and partially towards the rear front-panel side 32. The termination of the housing towards these sides is performed by inserting the guide part 24 and the terminal cover part 22, as described in more detail below. A screwless clamp connection 10 is mounted in the terminal connection area. The clamp connection 11 includes a clamping frame 101 with a clamping window 102, in which a clamping spring 12 is inserted. The clamping spring 12 has two clamping limbs, which can each press an inserted connecting conductor in clamping fashion against a clamping edge of the clamping frame 101, as is known from the prior art. The terminal connection area 18 is separated off from the rest of the housing interior when the housing is closed by dividing walls, of which one is illustrated in the illustration in FIG. 1, denoted by the reference numeral 181.

The terminal connection area 18 is covered towards the narrow side and towards the rear front-panel side 32 by a terminal cover part 22. The terminal cover part 22 functions as an actuating means for the clamping spring 12, in addition to the covering function. The terminal cover part 22 is approximately in the form of an “L” and has a long limb 221 and a short limb 222. An eyelet 223 is located at the free end of the long limb 221. By means of this eyelet 223, the terminal cover part 22 can be pushed onto a pin 5, which is fixed to the housing and which is fitted close to the fastening side 6 and close to the narrow side of the housing. The terminal cover part 22 is then pivotably connected to the housing, with the pin 5 acting as a pivot axis.

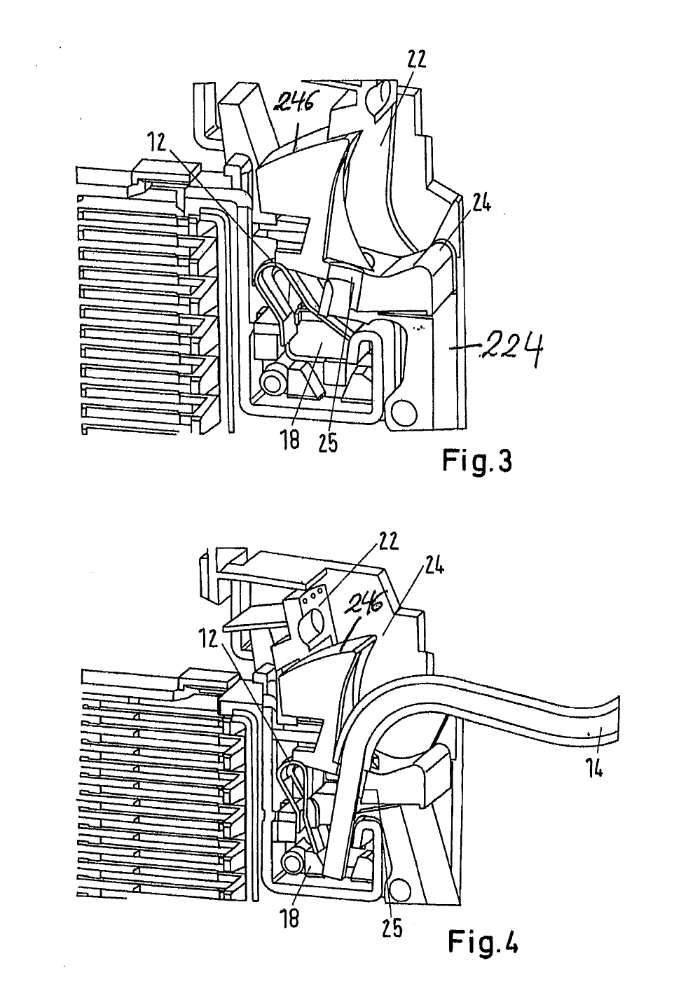

FIGS. 2 and 3 illustrate a terminal accommodating area with a terminal cover part and guide part inserted in accordance with the first exemplary embodiment. In FIGS. 2 and 3, the housing is shown with the terminal cover part 22 fastened pivotably thereto on the pin 5. A connecting surface 261, which is oriented perpendicular to the longitudinal direction of extent of the long limb 221, is located approximately centrally in the long limb 221. Two connecting openings 26 are located in the connecting surface. The connecting openings are elongate and oval and are larger than the outer diameter of the largest conductor end to be inserted. The long limb 221 is formed by a terminating plate 224 from the connecting surface 261 in the direction towards the free end of the long limb 221. The terminal cover part 221 has a pressure surface 225 on the free end of the long limb 221 which is opposite the pivot axis, it being possible for the pressure surface 225 to be used to pivot the terminal cover part 221 manually counter to the restoring force of the clamping spring 12 in the counterclockwise direction in the direction towards the housing interior. In addition, the short limb 222 is in the form of a cover plate at the free end of the long limb 221 which is opposite the pivot axis.

As shown in FIGS. 2 and 3, the clamping spring 12 presses with one of its spring arms against the left-hand end 262 of the connecting surface 261. The restoring spring force of the clamping spring 12 in this case has the effect that the terminal cover part 22 is pivoted in the clockwise direction. It is thus held in its initial position, in which the terminating plate 224 terminates the terminal connection area 18 on the narrow side towards the fastening side, and the short limb 221 terminates the terminal connection area 18 at the rear front-panel side, as an addition to that part of the rear front-panel side 32 which is connected to the housing.

In order to guide and hold a connecting conductor 14 (see FIG. 4) which has been inserted into one of the connecting openings 26, a guide part 24 is provided, which is fixedly connected to the housing. As shown in FIG. 1, the guide part is likewise in the form of an “L.” The guide part has a first limb 241, in which two adjacent guide channels 25 are located. The guide channels 25 in this case have a closed, circular cross-sectional contour, with an inner diameter which is matched to the outer diameter of the connecting conductors 14 to be inserted, with the result that the connecting conductors 14 to be inserted are guided effectively in the guide channels 25. The guide part 24 is connected to the housing 3 via lateral pins 242, which engage in corresponding blind holes 34 in the broad side of the housing, and latching hooks 243. The position of the guide part 24 with respect to the terminal cover part 22 is such that the first limb 241 of the guide part 24 with the guide channels 25 is above the connecting surface 261 of the terminal cover part 22 with the connecting openings 26, in the insertion direction of the connecting conductors, with both of said parts overlapping one another.

If the terminal cover part 22 is pivoted by virtue of pressure being applied to the pressure surface 225, the guide part 24 therefore does not change its position, but the connecting surface 162 of the terminal cover part 22 is pivoted below the first limb 241 of the guide part 24. Connecting conductors which have been inserted into the guide channels 25 are therefore held fixedly by the guide part 24 when the terminal cover part 22 is pivoted. The connecting openings 26 are dimensioned to have such a length that the connecting ends of the inserted connecting conductors cannot impede pivoting of the terminal cover part. Secondly, bending of the connecting conductors cannot influence the terminal cover part either. The guide part 24 acts as a stop edge to a certain extent for the inserted connecting conductors. As shown in FIGS. 2 and 3, the connecting conductor 14 is held in the guide channel 25 while the terminal cover part 22 is pivoted below the guide part 24 into the housing interior and thus acts on the clamping limb of the clamping spring 12 to cause the terminal to open, with the result that the connecting conductor can be clamped fixedly between the free limb of the clamping spring and the clamping frame.

A second limb 244 is integrally formed on the free end of the first limb 241 which points into the housing interior, said second limb extending in the direction towards the front-panel side of the housing and forming a further part, on the front-panel side, of the housing cover on the narrow side (see FIGS. 2 and 3). In order to reinforce the second limb, a web 245 is located between the two guide channels 25.

Furthermore, a curved sliding surface 246 is integrally formed on the free end of the second limb 244. The sliding surface likewise points into the interior of the housing and serves the purpose of guiding the terminal cover part 22 during the pivoting thereof into the housing interior.

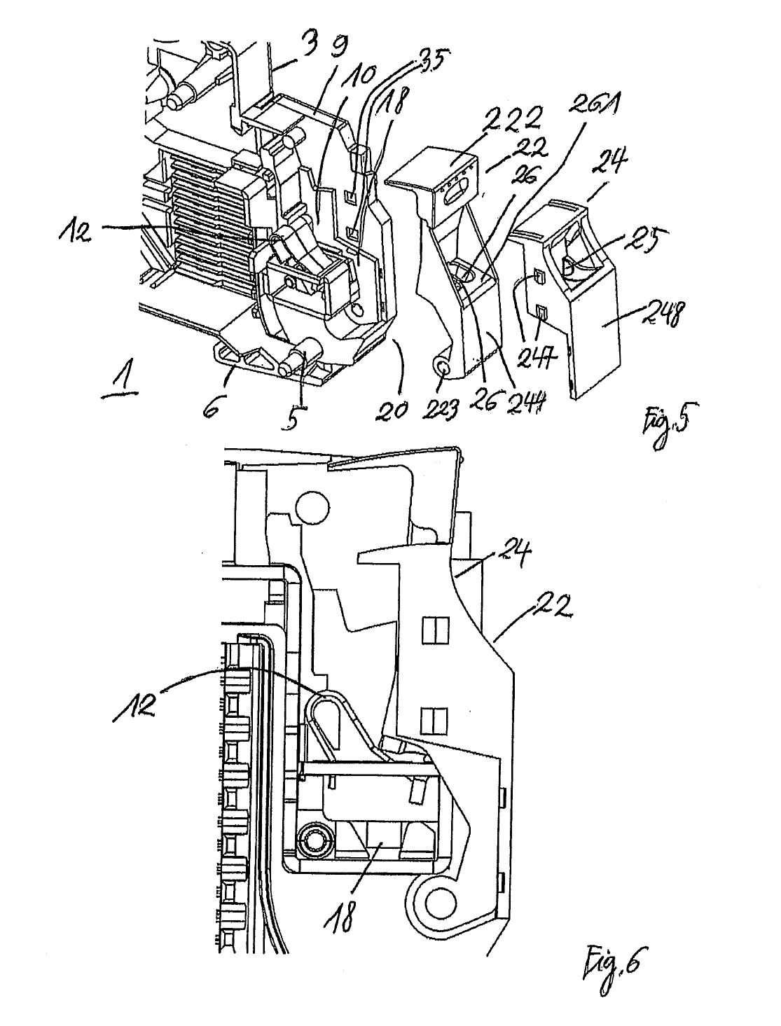

FIGS. 5 to 8 illustrate a second exemplary embodiment of the disclosure. In particular the differences with respect to the embodiment shown in FIGS. 1 to 4 will be described. In the second embodiment, the guide part 24 is in the form of a box which is open on one side, such that the side surfaces of said box can be latched by means of latching knobs 247 in corresponding latching depressions 35 in the inner side of the housing broad sides. As a result, the guide part 24 in this embodiment is likewise fixedly connected to the housing. A front side 248 of the guide part 24 is extended downwards towards the fastening side. When the guide part 24 has been inserted into the housing, this front side 248 of the guide part then forms part of the rear narrow side of the housing here. In the fitted state, the second limb 244 of the terminal cover part 22 then bears on the inside against the front side 248 of the guide part 24 (see FIGS. 6 to 8). The guide channels 25 in the guide part 24 in this case have a partially open cross-sectional contour; they have a segment-like opening with an opening angle of less than 180°. As a result, connecting conductors 14 are held in the guide channels 25. The limbs of the cross-sectional contour now act as stop edge, which holds the connecting conductor firmly relative to the terminal cover part 22.

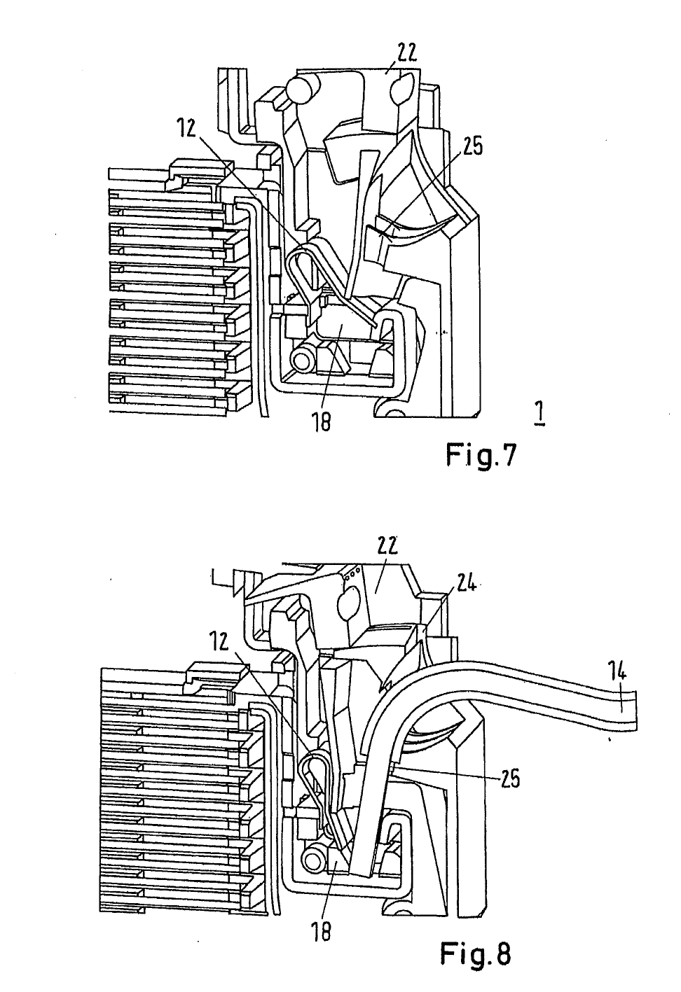

The connecting surface 261 of the terminal cover part 22 is in the second embodiment, shorter than the corresponding connecting surface of the terminal cover part as shown in FIGS. 1 to 4 of the first embodiment. The extent of this shortening is approximately of the order of magnitude of the thickness of the front side 248 of the guide part 24 (see FIG. 7) since the second limb 244 in the embodiment shown in FIGS. 5 to 8 is positioned further in the housing interior by this thickness. As a result, the pivot axis of the terminal cover part enters further into the housing interior, in comparison with the first embodiment shown in FIGS. 1 to 4. The short limb 222 of the terminal cover part 22 can thus be shorter.

The guide part 24 and the terminal cover part 22 can be manufactured as injection-molded parts from insulating polymer, in a very advantageous manner.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Installation switching device
3 Housing
4 Arc splitter stack
5 Pin
6 Fastening side
10 Screwless clamp connection
12 Clamping spring
14 Connecting conductor
18 Terminal connection area
20 Opening of terminal connection area
22 Terminal cover part
24 Guide part
25 Guide channel
26 Connecting opening
31 Broad side
32 Rear front-panel side
33 Front narrow side
34 Blind hole
35 Latching depression
61 Tab
101 Clamping frame
102 Clamping window
181 Dividing wall
221 Long limb
222 Short limb
223 Eyelet
224 Terminating plate
225 Pressure surface
241 First limb
242 Pin
243 Latching hook
244 Second limb 245 Web
246 Sliding surface
247 Latching knob
248 Front side
261 Connecting surface
262 Left-hand end of connecting surface

What is claimed is:

1. An installation switching device, comprising:
a housing, having a front-panel side, a fastening side, narrow sides and broad sides;
a screwless terminal connection having a clamping spring for the connection of connecting conductors, said clamping spring is fixed in a position in an opening of a terminal connection area of the housing,
wherein the opening of the terminal connection area is partially covered by a terminal cover part, wherein the terminal cover part is pivotably connected to the housing, has a number of connecting openings in a connecting face which corresponds to the number of connecting conductors to be connected, and acts upon the clamping spring to open the spring in an event of pivoting in a direction towards the housing interior,
wherein the opening in the terminal connection area is also partially covered by a guide part, which is coupled fixedly to the housing, said guide part overlaps a region of the terminal cover part and has guide channels for narrowly guiding the connecting conductors.

2. The installation switching device as claimed in claim 1, wherein the guide part and the terminal cover part overlap one another in the region of the guide channels and the connecting openings.

3. The installation switching device as claimed in claim 2, wherein the guide part forms a stop edge for an inserted connecting conductor.

4. The installation switching device as claimed in claim 1, wherein the guide channels have a closed cross-sectional contour.

5. The installation switching device as claimed in claim 4, wherein the guide channels have a closed circular cross section.

6. The installation switching device as claimed in claim 1, wherein the guide channels have a partially open cross-sectional contour.

7. The installation switching device as claimed in claim 6, wherein the guide channels have a segment-like opening of the cross-sectional contour with an opening angle of less than 180°.

8. The installation switching device as claimed in claim 1, wherein the terminal cover part is in the form of an L, wherein the pivot axis is located at the free end of the long limb, and the short limb serves to cover the terminal connection area in the direction of the rear front-panel side.

9. The installation switching device as claimed in claim 8, wherein the terminal cover part has a pressure surface, which is accessible from the outside and can be actuated manually, at the transition between the long limb and the short limb.

10. The installation switching device as claimed in claim 1, wherein the guide part is in the form of a box which is open on one side and has side faces which can be latched with the broad sides of the housing.

11. The installation switching device as claimed in claim 10, wherein a front side of the guide part is extended in the direction towards the pivot axis, with the result that it forms part of the narrow side of the housing.

12. The installation switching device as claimed in claim 1, wherein the guide part is in the form of an L, wherein a first limb bears the guide channels and overlaps with the connecting surface of the terminal cover part.

13. The installation switching device as claimed in claim 12, wherein the first limb is coupled fixedly to the housing and, in the installed position, points into the housing interior from the narrow side.

14. The installation switching device as claimed in claim 13, wherein a second limb is integrally formed on that free end of the first limb which is located in the housing interior, said second limb extending in the direction towards the front-panel side of the housing and forming part of the narrow side cover on the front-panel side.

15. The installation switching device as claimed in claim 1, wherein a sliding surface is integrally formed on the guide part, points into the interior of the housing and serves to guide the terminal cover part during its pivoting movement.

16. The installation switching device as claimed in claim 2, wherein the device is a line circuit breaker, a residual current circuit breaker, or a motor circuit breaker.
